(19) United States
(12) Patent Application Publication
(10) Pub. No.: US 2017/0229849 A1
(43) Pub. Date: Aug. 10, 2017

(54) HOLDER AND HOLDER THAT MAY BE USED AS A COVER

(71) Applicant: Gerald Beranek, North Liberty, IA (US)

(72) Inventor: Gerald Beranek, North Liberty, IA (US)

(21) Appl. No.: 15/502,217

(22) PCT Filed: Aug. 10, 2015
(86) PCT No.: PCT/US15/44500

§ 371 Date: Feb. 7, 2017

Related U.S. Application Data
(60) Provisional application No. 62/034,878, filed on Aug. 8, 2014.

(51) Int. Cl. H02G 3/04; A47B 95/00; H01R 13/52

(52) U.S. Cl. CPC H02G 3/0456; H02G 3/0418; H01R 13/5213; A47B 95/008

(57) ABSTRACT

Disclosed is a cover which may include an attachment section and at least one wing having at least one holder therein, wherein the attachment section is configured to attach to a wall socket.

### CROSS-REFERENCE TO RELATED APPLICATIONS

This application claims priority to PCT/US15/44500 filed on Aug. 10, 2015, which claims priority from U.S. Provisional Application No. 62/034,878, which was filed on Aug. 8, 2014. This application claims priority to each of the above referenced applications and the disclosures of each of the above-referenced applications are hereby incorporated by reference in their entirety

### BACKGROUND

1. Field

Example embodiments relate to a holder and a cover that may be used as a holder. In example embodiments the cover may be configured to cover an electrical socket while providing a plurality of holders.

2. Description of the Related Art

Electrical devices, for example, electrical outlets, are placed in spaces formed in a wall. Such spaces, however, are generally unsightly. Outlet covers are typically used to cover these spaces to make for a more aesthetically pleasing environment. Conventional outlet covers typically resemble a flat plate with one or two openings. While conventional outlet covers typically serve their purpose for covering up the aforementioned spaces, they generally serve no other purpose.

### SUMMARY

Applicants have developed a new outlet covering that not only presents an aesthetically pleasing structure but adds additional functionality to the cover. Applicants have also invented a novel holder that may be used to hold multiple items.

In accordance with example embodiments, a cover may include an attachment section and at least one wing having at least one holder therein, wherein the attachment section is configured to attach to a wall socket.

### BRIEF DESCRIPTION OF THE DRAWINGS

Example embodiments are described in detail below with reference to the attached drawing figures, wherein:

FIG. 1A is a perspective view of a cover in accordance with example embodiments;

FIG. 1B is a front view of the cover in accordance with example embodiments;

FIG. 1C is a back view of the cover in accordance with example embodiments;

FIG. 1D is a side view of the cover in accordance with example embodiments;

FIG. 2A is an exploded view of a system in accordance with example embodiments;

FIG. 2B is view of the cover on a wall socket in accordance with example embodiments;

FIG. 2C is a view of a conventional cover in a lip of the cover in accordance with example embodiments;

FIG. 3A is a perspective view of a cover in accordance with example embodiments;

FIG. 3B is a front view of the cover in accordance with example embodiments;

FIG. 3C is a side view of the cover in accordance with example embodiments;

FIG. 4 is a view of a system in accordance with example embodiments;

FIG. 5A is a perspective view of a cover in accordance with example embodiments;

FIG. 5B is a front view of the cover in accordance with example embodiments;

FIG. 5C is a side view of the cover in accordance with example embodiments;

FIG. 6 is a view of a system in accordance with example embodiments;

FIGS. 7A-7E are views of a system in accordance with example embodiments;

FIG. 8 is a view of a connecting member in accordance with example embodiments;

FIGS. 9A-9D are views of a cover in accordance with example embodiments;

FIGS. 10A-10D are views of an accessory in accordance with example embodiments; and

FIGS. 11A-11D are views of a system in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the example embodiments set forth herein. Rather, these example embodiments are provided so that this disclosure will be thorough and complete, and will fully convey the scope of the invention to those skilled in the art. In the drawings, the sizes of components may be exaggerated for clarity.

In this application, it is understood that when an element or layer is referred to as being “on,” “attached to,” “connected to,” or “coupled to” another element or layer, it can be directly on, directly attached to, directly connected to, or directly coupled to the other element or layer or intervening elements that may be present. In contrast, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application it is understood that, although the terms first, second, etc. may be used herein to describe various elements and/or components, these elements and/or components should not be limited by these terms. These terms are only used to distinguish one element, component, region, layer, and/or section from another elements, component, region, layer, and/or section. Thus, a first element, component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to planform views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to cover. In example embodiments the cover may be configured to cover an electrical socket. Example embodiments are also related to a holder that may be configured to hold a plurality of items.

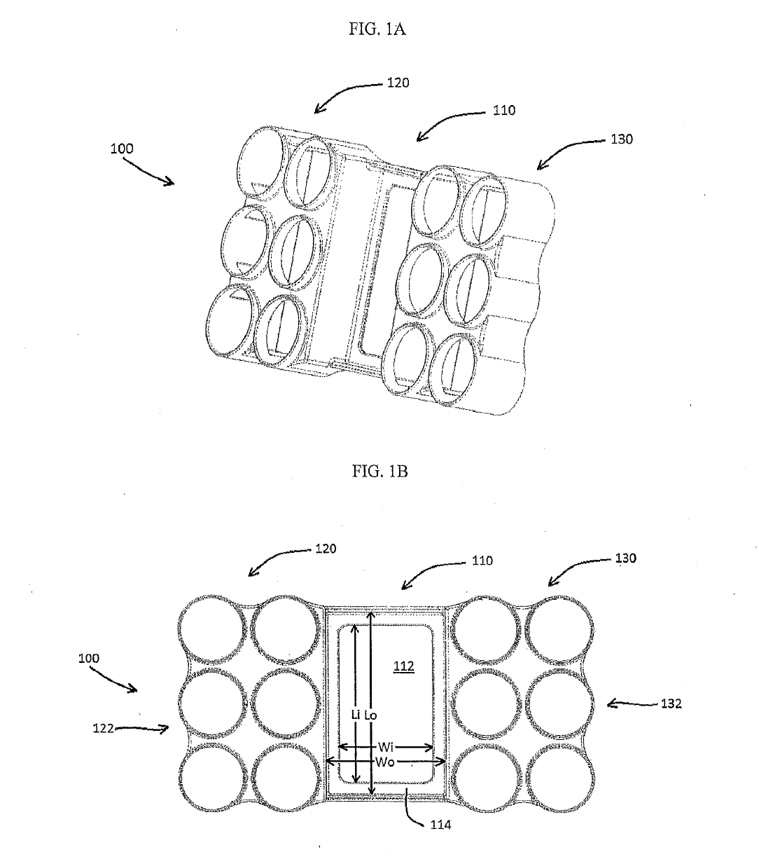

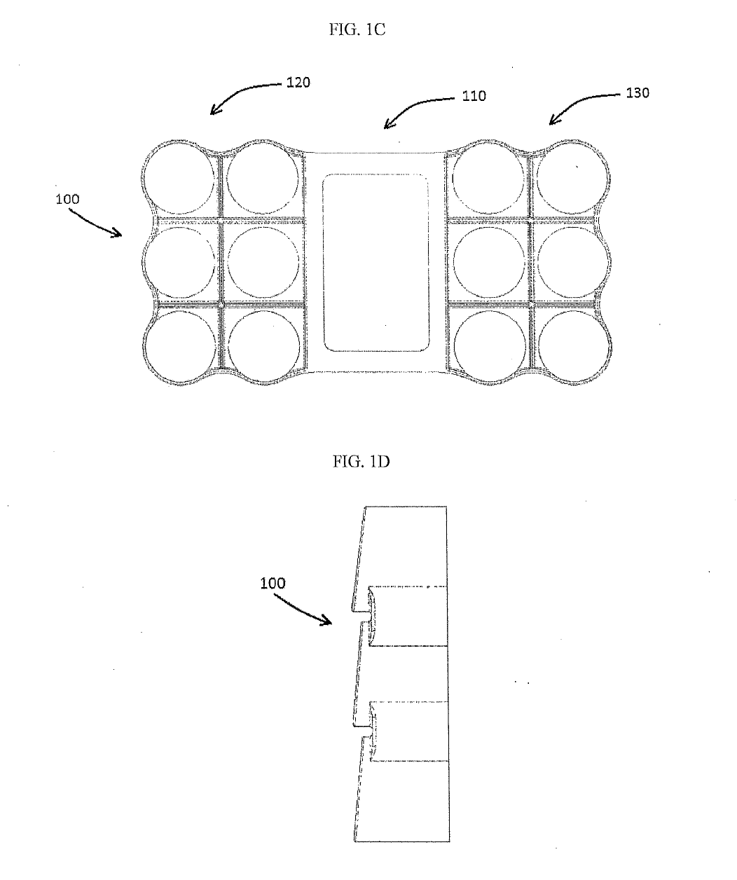

FIG. 1A is a view of a cover 100 in accordance with example embodiments. As shown in FIG. 1A, the cover 100 may include an attachment section 110 for attaching the cover 100 to a structure, for example, a conventional wall socket such as a duplex electrical socket 400. In example embodiments, the cover 100 may include a first wing 120 and a second wing 130 extending from the attachment section 110. Although FIG. 1A illustrates an embodiment with two wings 120 and 130, the invention is not limited thereto. For example, in example embodiments only one wing may extend from the attachment section 110 or more than two wings may extend from the attachment section 110. For example, in example embodiments four wings may extend from the attachment section 110 to form a cross shaped cover. Regardless, in example embodiments, the cover 100 may include at least one wing.

In example embodiments, the wings 120 and 130 may include a plurality of holders. For example, the first wing 120 may include a first plurality of holders 122 and the second wing 130 may include a second plurality of holders 132. In example embodiments, the plurality of holders 122 and 132 may resemble substantially hollow cylinders and various items, for example, jars, may be placed in the holders 122 and 132 for storage. Although the figures show each wing as including six holders 122 and 132, the invention is not limited thereto, for example, each wing 120 and 130 may include only a single holder, less than six holders, or more than six holders. Furthermore, the holders 122 and 132 are not required to be cylindrical members. For example, in example embodiments the holders 122 and 132 may simply resemble small shelves, hooks, or rectangular tubes rather than cylindrical tubes. In addition, although the figures show equal numbers of holders 122 and 132, this is not intended to limit the invention. For example, the first wing 120 may include only four holders 122 and the second wing 132 may include more or less than four holders 132.

In example embodiments, the attachment section 110 may include an aperture 112 surrounded by a lip 114. In example embodiments, the aperture 112 may be configured to expose a conventional electrical socket, for example, a conventional duplex socket 400. In example embodiments, the lip 114 may be configured to receive a conventional socket cover plate 500. For example, a standard cover plate 500 may have a length of about 4.5 inches and a width of about 2.75 inches. As such, the lip 114 may have an outer width Wo of larger than 2.75 inches and an outer length Lo of larger than 4.5 inches. As for the aperture 112, a width Wi of the aperture 112 may be less than about 2.75 inches and a length Li of the aperture 112 may be less than about 4.5 inches. As such, a conventional socket cover 500 may fit on the lip 114. It should be understood, however, that the dimensions provided herein are simply for the purpose of example and are not intended to limit the invention.

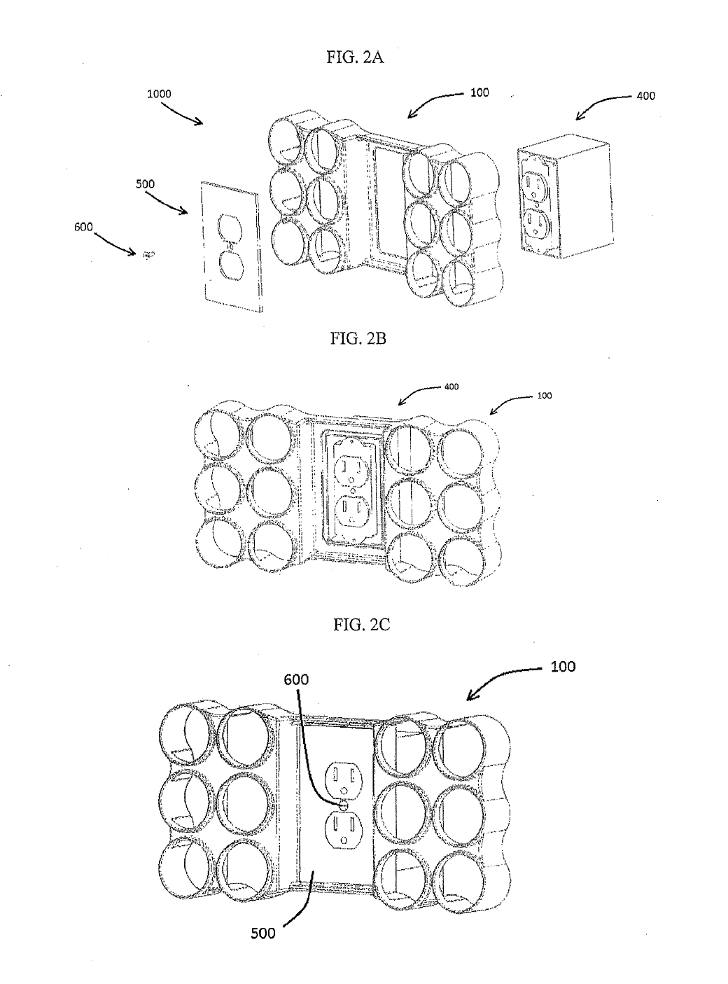

FIG. 2A is an exploded view of a system 1000 in accordance with example embodiments. As shown in FIG. 2A, the system 1000 may include the cover 100, an electrical socket 400, a cover plate 500, and an attachment member 600. In example embodiments the cover 100 may be placed over the electrical socket 400 in a manner than exposes the electrical socket 400 as shown in FIG. 2B. After the cover 100 is placed over the socket 400 the cover plate 500 may be placed in the lip 114 and secured to the socket 500 via a fixing member 600, for example, a screw, as shown in FIG. 2C. In this manner, the cover 100 is sandwiched between a wall in which the socket 400 is installed and the cover plate 500 allowing the cover 100 to be secured in place.

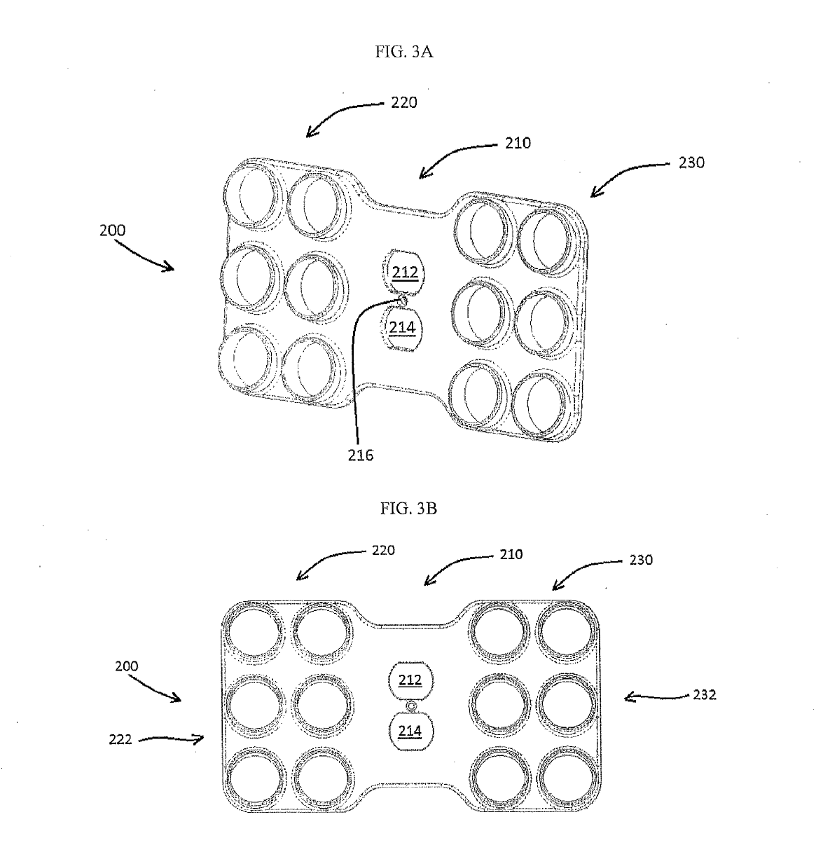

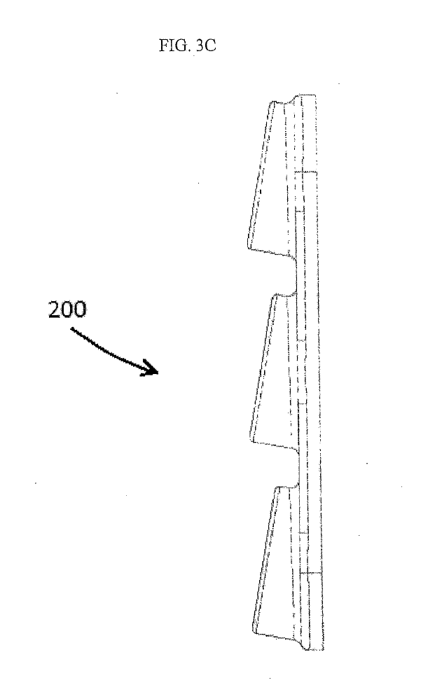

FIG. 3A is a view of a cover 200 in accordance with example embodiments. As shown in FIG. 3A, the cover 200 may include an attachment section 210 for attaching the cover 200 to an conventional wall socket, for example, a duplex electrical socket 400. In example embodiments, the cover 200 may include a first wing 220 and a second wing 230 extending from the attachment section 210. Although FIG. 3A illustrates an embodiment with two wings 220 and 230, the invention is not limited thereto. For example, in example embodiments only one wing may extend from the attachment section 210 or more than two wings may extend from the attachment section 210. Thus, in example embodiments, the cover 200 may include at least one wing.

In example embodiments, the wings 220 and 230 may include a plurality of holders. For example, the first wing 220 may include a first plurality of holders 222 and the second wing 230 may include a second plurality of holders 232. In example embodiments, the plurality of holders 222 and 232 may resemble substantially hollow cylinders and various items, for example, jars, may be placed in the holders 222 and 232 for storage. Although the figures show each wing as including six holders 222 and 232, the invention is not limited thereto, for example, each wing 220 and 230 may include only a single holder, less than six holders, or more than six holders. Furthermore, the holders 222 and 232 are not required to be cylindrical members. For example, in example embodiments the holders 222 and 232 may simply resemble small shelves, hooks, or rectangular tubes rather than cylindrical tubes. In addition, although the figures show equal numbers of holders 222 and 232, this is not intended to limit the invention. For example, the first wing 220 may include only four holders 222 and the second wing 232 may include more or less than four holders 232.

In example embodiments, the attachment section 210 may include a first aperture 212 and a second aperture 214 configured to expose the sockets of a conventional duplex socket 400. In example embodiments, a third aperture 216 may be provided so that the cover 200 may be attached to the socket 400 by a fixing member 600, for example, a screw.

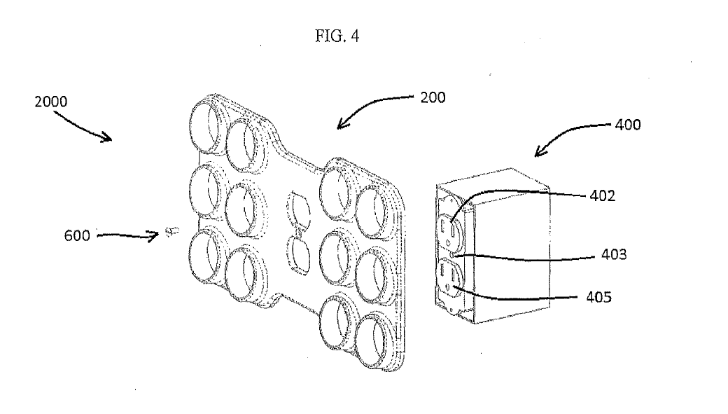

FIG. 4 is a view of a system 2000 in accordance with example embodiments. As shown in FIG. 4, the system 2000 may include an electrical socket 400, the cover 200, and the fixing member 600. As shown in FIG. 4, the socket 400 may include a hole 403 which may be configured receive the fixing member 600. Thus, in this example, the cover 200 may be placed over the socket 400 so that its third aperture 216 is aligned with the hole 403 of the socket 400 and so that the first and second apertures 212 and 214 are aligned with the sockets 402 and 405 of the duplex socket 400. The fixing member 600 may then be threaded through the third aperture 216 of the cover 200 and into the hole 403 of the duplex socket 400 to secure the cover 200 to the duplex socket 400.

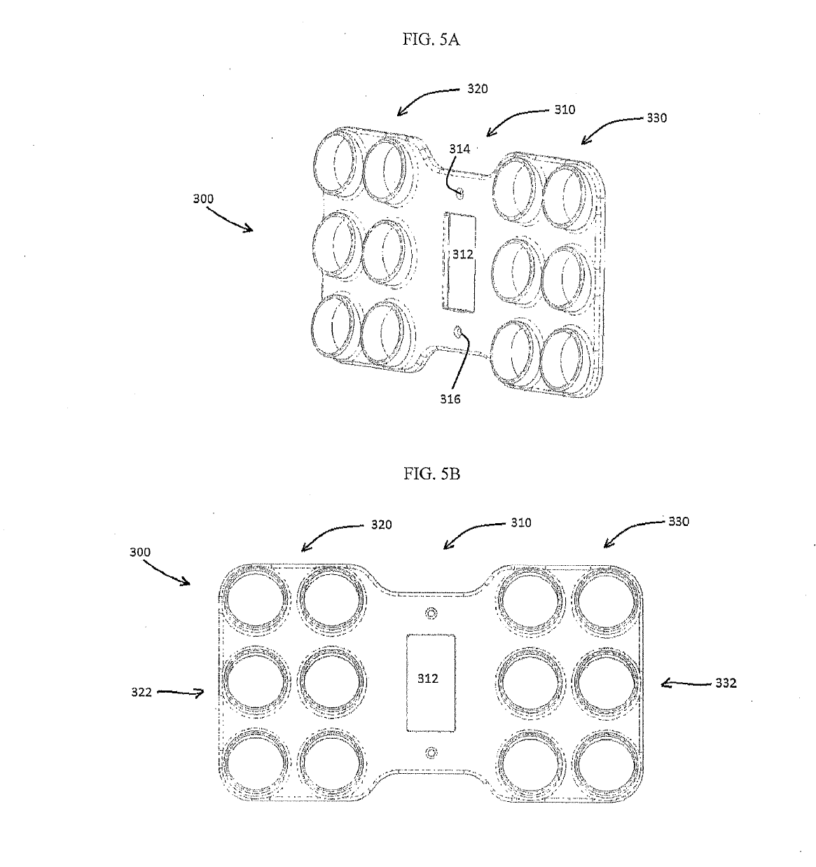

FIG. 5A is a view of a cover 300 in accordance with example embodiments. As shown in FIG. 5A, the cover 300 may include an attachment section 310 for attaching the cover 300 to a conventional wall socket, for example, a duplex electrical socket 400. In example embodiments, the cover 300 may include a first wing 320 and a second wing 330 extending from the attachment section 310. Although FIG. 5A illustrates an embodiment with two wings 320 and 330, the invention is not limited thereto. For example, in example embodiments only one wing may extend from the attachment section 310 or more than two wings may extend from the attachment section 310. Thus, in example embodiments, the cover 300 may include at least one wing.

In example embodiments, the wings 320 and 330 may include a plurality of holders. For example, the first wing 320 may include a first plurality of holders 322 and the second wing 330 may include a second plurality of holders 332. In example embodiments, the plurality of holders 322 and 332 may resemble substantially hollow cylinders and various items, for example, jars, may be placed in the holders 322 and 332 for storage. Although the figures show each wing as including six holders 322 and 332, the invention is not limited thereto, for example, each wing 320 and 330 may include only a single holder, less than six holders, or more than six holders. Furthermore, the holders 322 and 332 are not required to be cylindrical members. For example, in example embodiments the holders 322 and 332 may simply resemble small shelves, hooks, or rectangular tubes rather than cylindrical tubes. In addition, although the figures show equal numbers of holders 322 and 332, this is not intended to limit the invention. For example, the first wing 320 may include only four holders 322 and the second wing 332 may include more or less than four holders 332.

In example embodiments, the attachment section 310 may include a first aperture 312 configured to expose the sockets of a conventional duplex socket 400. In example embodiments, a second and third aperture 314 and 316 may be provided so that the cover 300 may be attached to a socket 400 by a pair of fixing members 600, for example a pair of screws. In example embodiments, the second and third apertures 314 and 316 may be separated by a distance of about 2.5, 3, 3.5, 4, or 4.5 inches.

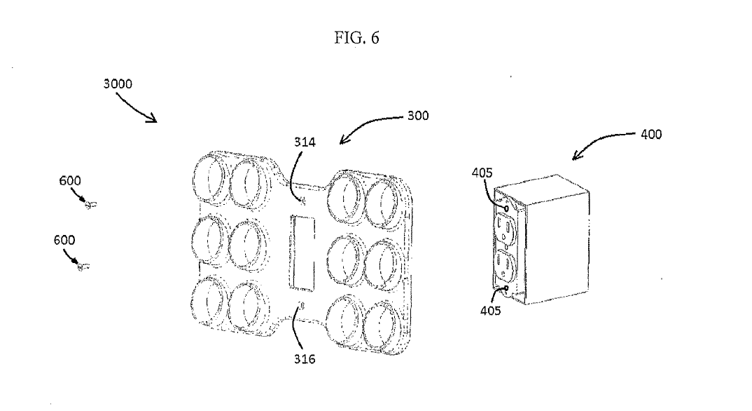

FIG. 6 is a view of a system 3000 in accordance with example embodiments. As shown in FIG. 6, the system 3000 may include an electrical socket 400, the cover 300, and the fixing members 600. As shown in FIG. 6, the socket 400 may include a pair of holes 405 which may be configured receive the fixing members 600. Thus, in this example, the cover 300 may be placed over the socket 400 so that its second and third aperture 314 and 316 are aligned with the pair of holes 405 of the socket 400 and so that the first aperture 312 is aligned with the sockets 402 and 403 of the duplex socket 400. The fixing members 600 may then be threaded through the second and third apertures 314 and 316 of the cover 300 and into the holes 405 of the duplex socket 400 to secure the cover 300 to the duplex socket 400.

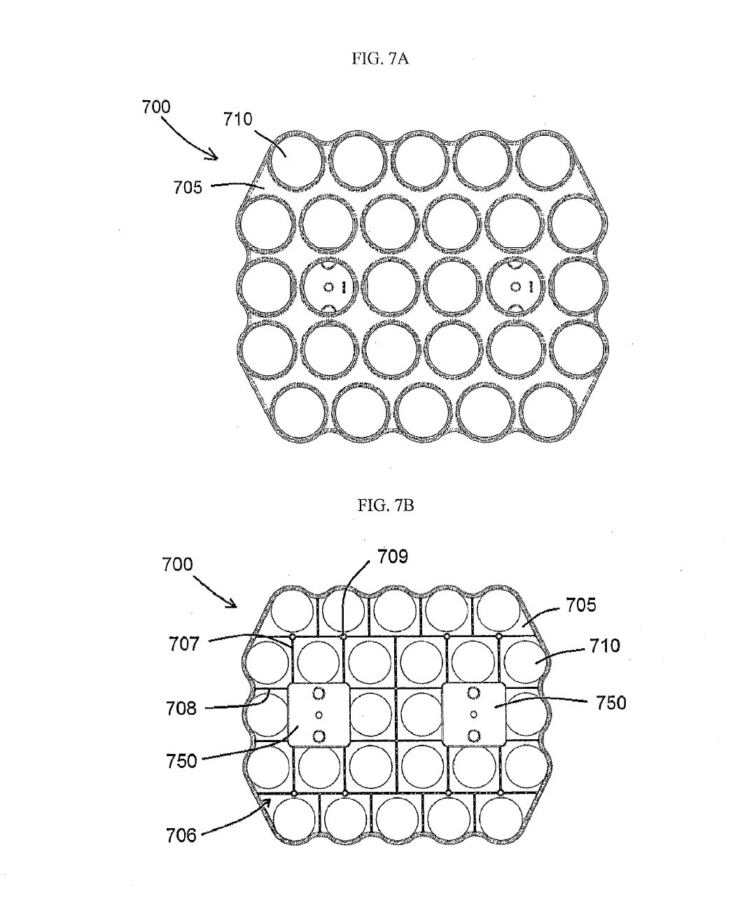

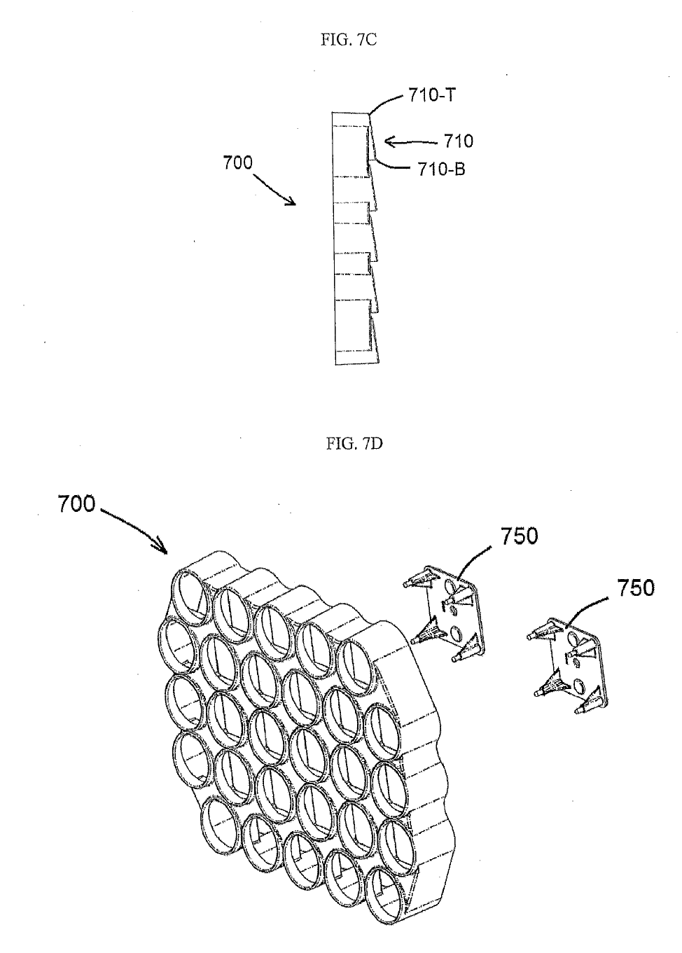

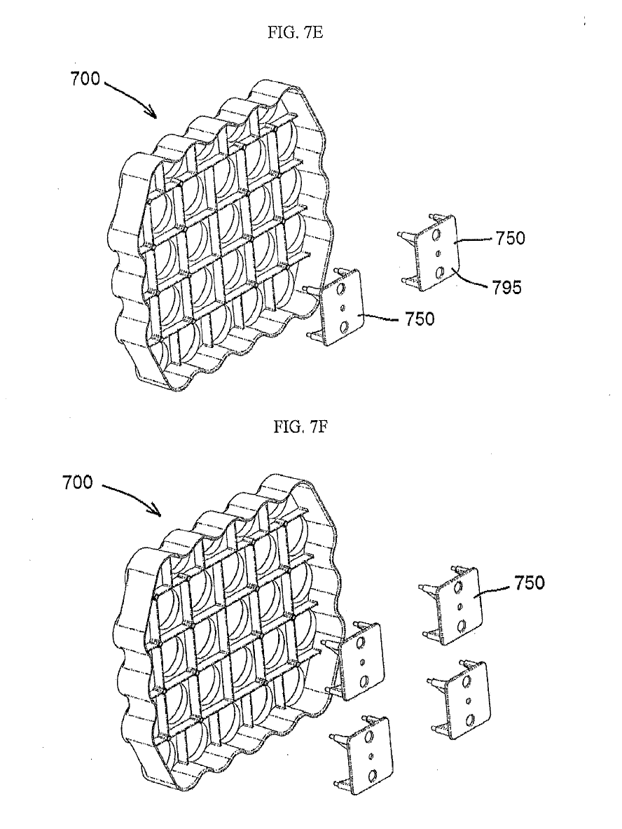

FIGS. 7A-7E are views of a system 700 in accordance with example embodiments. FIG. 7A, for example, is a front view of the system 700, FIG. 7B is a back view of the system 700, FIG. 7C is a side view of the system 700, FIG. 7D is a first exploded/perspective view of the system 700, and FIG. 7E is a second exploded/perspective view of the system 700. As shown in FIGS. 7A-7E, the system 700 may include a holder body 705 and connecting members 750 configured to attach the holder body 705 to a structure, for example, a wall. In example embodiments, holder body 705 may resemble a substantially flat plate with a plurality of ribs 706 extending from a back side thereof (see FIG. 7B). In example embodiments, the holder body 705 may also include a plurality of holders 710 which may resemble substantially hollow cylinders. In example embodiments, various items, for example, jars, may be placed in the holders 710. Although FIG. 7A shows the holder 700 as having twenty-eight holders 710 the invention is not limited thereto. For example, the holder 700 may include only a single holder 710, less than twenty-eight holders 710, or more than twenty-eight holders 710. Furthermore, the holders 710 are not required to be cylindrical members. For example, in example embodiments the holders 710 may simply resemble small shelves, hooks, or rectangular tubes rather than cylindrical tubes. Also, in example embodiments, bottom portions 710-B of the holders 710 may extend further from the holder body 705 than the top portions 710-T of the holders 710 as shown in at least FIG. 7C. This aspect of example embodiments may allow for items to more securely reside in the holders 710.

FIG. 7B illustrates a back view of the holder body 705. As shown in FIG. 7B, a back of the holder body 705 may include the plurality of ribs 706. In example embodiments the plurality of ribs 706 may be arranged to form a pattern, for example, a rectangular pattern. For example, the plurality of ribs 706 may include a plurality of vertical ribs 707 and a plurality of horizontal ribs 808. In example embodiments, the vertical ribs 707 and the horizontal ribs 708 may meet a receiving port 709 which may resemble a hollow cylinder. The receiving ports 709 may be configured to receive interfacing members 772 of connecting member 750.

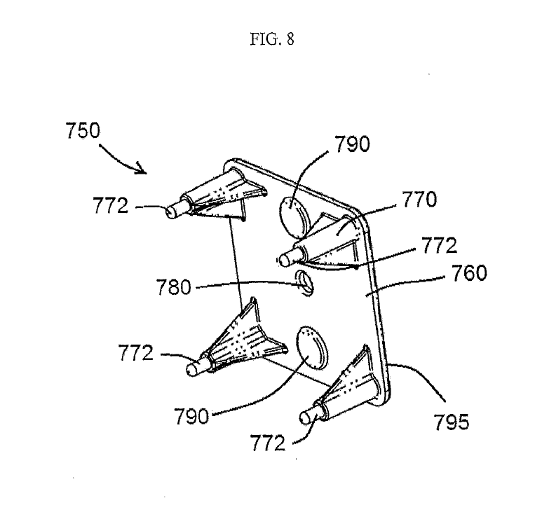

FIG. 8 is a perspective view of a connecting member 750. As shown in FIG. 8, the connecting member 750 may include a connecting body 760 which may, but is not required to, resemble a flat plate. In example embodiments the connecting member 750 may include four legs 770 extending from the connecting body 760. The four legs 770 may resemble posts with interfacing members 772 configured to interface with the receiving ports 709 of the holder body 705. For example, the interfacing members 772 may resemble cylinders which may insert into the receiving ports 709 of the holder body 705. For example, each of the connecting members of FIGS. 7A-7E may include four interfacing members 772 and each of the four interfacing members may insert into a receiving port 709 of the holder body 705.

In example embodiments, the connecting bodies 760 of the connecting members 750 may include an aperture 780 which may be configured to allow a portion of a fastener, for example, a screw or a nail, to pass through. In example embodiments the holder body 705 may be mounted to a wall via the connecting members 750. For example, in one embodiment, a first connecting member 750 may be arranged so that four of the first interfacing members 772 are aligned with four receiving ports 709. The connecting member 750 may then be moved so that the four interfacing members 772 are inserted into four receiving ports 709 of the holder body 705. Then, a second a connecting member 750 may be arranged so that four interfacing members 772 of the second connecting member 750 are aligned with four other receiving ports 709 of the holder body 705. The second connecting member 750 may then be moved so that its four interfacing members 772 are inserted into the other four receiving ports 709. The fasteners may then be used to attach the holder body 705 to a wall via the first and second connecting members 750. Example embodiments are not intended to be limited by the above description. For example, in example embodiments the connecting body 760 may include dents 790 into which a magnet may be placed. Although the embodiment of FIG. 8 illustrates two dents 790 it is clear the connecting body 760 may include a single dent or more than two dents into which a magnet may be placed. This latter embodiment may allow a user to attach the connecting member 750 to a surface, for example, a metal surface, without the use of a fastener that resembles a screw and/or nail. As yet another example, the back surface 795 may include an adhesive. The adhesive may allow a user to attach the connecting member 750 to a surface without the use of either the magnets and/or a fastener that resembles a nail and/or a screw. Of course, when used in conjunction with the magnets, the combination of the magnets and the adhesive would make for a relatively strong bond which neither the magnets nor the adhesive alone would achieve.

Although the system of FIGS. 7A-7E illustrate two connecting members 750 connecting the holder body 705 to a structure, for example, a wall, the invention is not limited thereto. For example, in another embodiment, only a single connecting member 750 may be used to connect a holder body 705 to a wall. In another embodiment, three connecting members 750 may be used to connect the holder body 705 to the structure, in yet another embodiments, for example, as shown in FIG. 7F, four connecting members 750 may be used to connect the holder body 705 to a structure.

It is understood there are various modifications to the holder bodies 705 and connecting members 750. For example, in FIGS. 7A-7E the holder body 705 is illustrated as having receiving ports 709 arranged in a rectangular pattern, this, however, is not meant to limit the invention. For example, rather than arranging the ports 709 in a rectangular pattern, the receiving ports 709 may be arranged in a triangular pattern. In this latter embodiment it is understood the connecting members 750 would be configured to include three interfacing members 772 arranged so as to interface with the triangular pattern of receiving ports 709 of the holder body 705. In yet another embodiment, instead of the receiving ports resembling hollow cylinders, the receiving ports 709 may resemble solid cylinders and the interfacing members 772 may resemble hollow cylindrical members configured to receive the solid cylinders of the receiving ports 709. Also, although receiving ports 709 are illustrated as being configured to receive a cylindrical member, the interfacing members 772 may have a polygonal cross-section, for example, a square cross section or a triangular cross section, and the receiving port 709 may likewise have a space defined by a polygonal cross-section, for example, a square cross section or a triangular cross section, configured to accommodate the interfacing members 772.

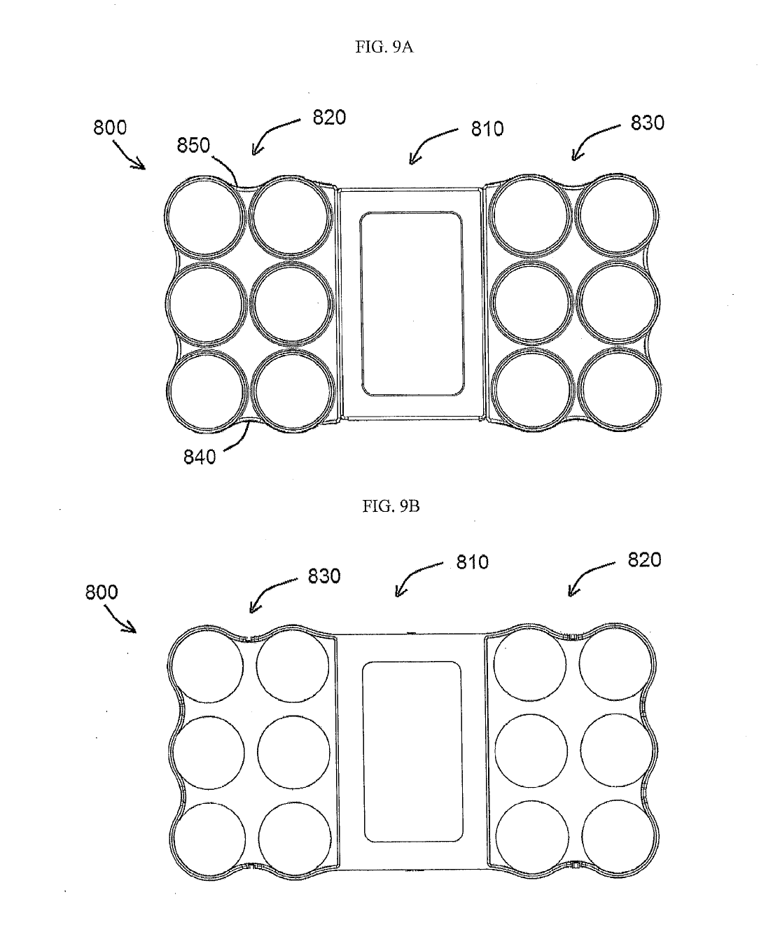

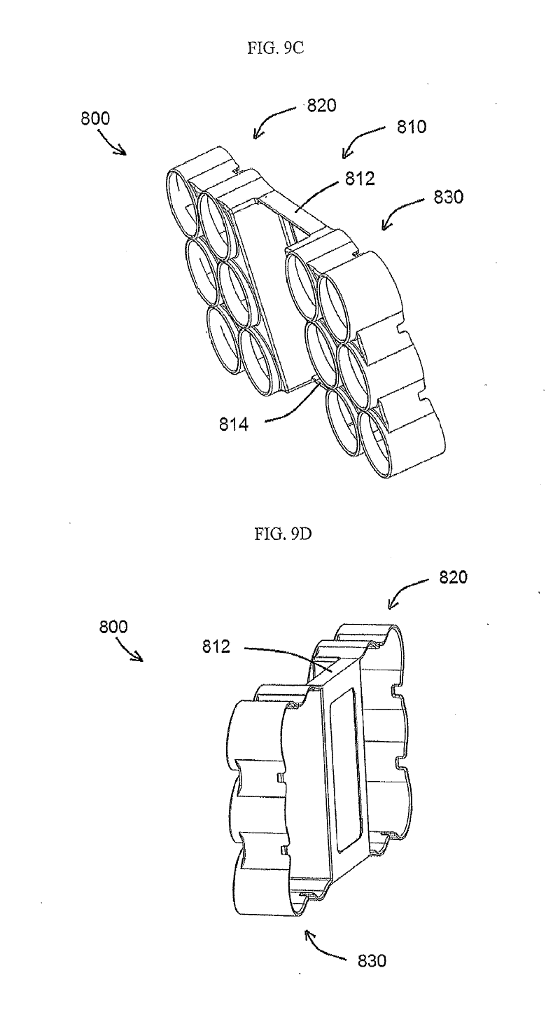

FIGS. 9A-9D illustrate a cover 800 in accordance with example embodiments. FIG. 9A, for example, is a front view of the cover 800, FIG. 9B is a back view of the cover 800, FIG. 9C is a first perspective view of the cover 800, and FIG. 9D is a second perspective view of the cover 800. The cover 800 may be substantially identical to the previously described cover 100 in that the cover 800 may have an attachment section 810, a first wing 820, and a second wing 830 wherein each of the first wing 810 and the second wing 820 include a plurality of holders. FIGS. 9A-9D illustrate an accessory 900 which may be attached to the cover 800. For example, FIG. 9A is a front view of the accessory 900, FIG. 9B is a back view of the accessory 900, FIG. 9C is a first perspective view of the accessory 900, and FIG. 9D is a second perspective view of the accessory 900.

In FIG. 9A the cover 800 includes a first surface 840 and a second surface 850. The accessory 900 includes a third surface 920 which may be complementary to the first and/or second surfaces 840 and/or 850. This aspect of example embodiments allows the third surface 920 to nest with either the first surface 840 or second surface 850.

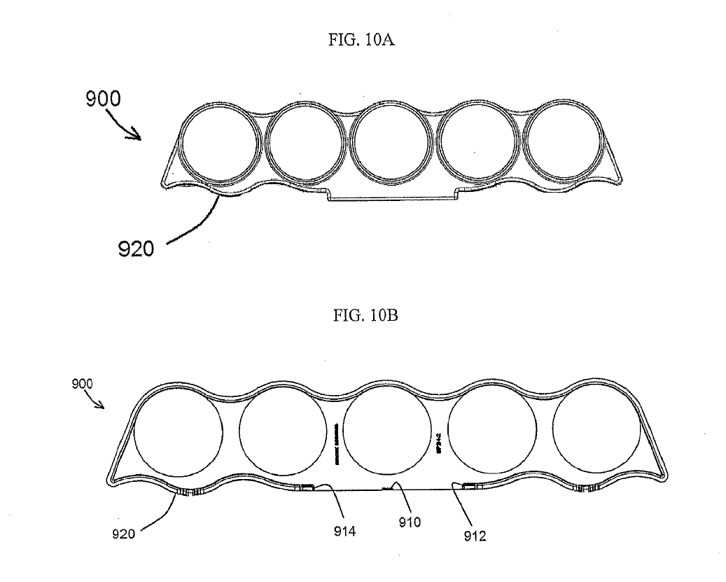

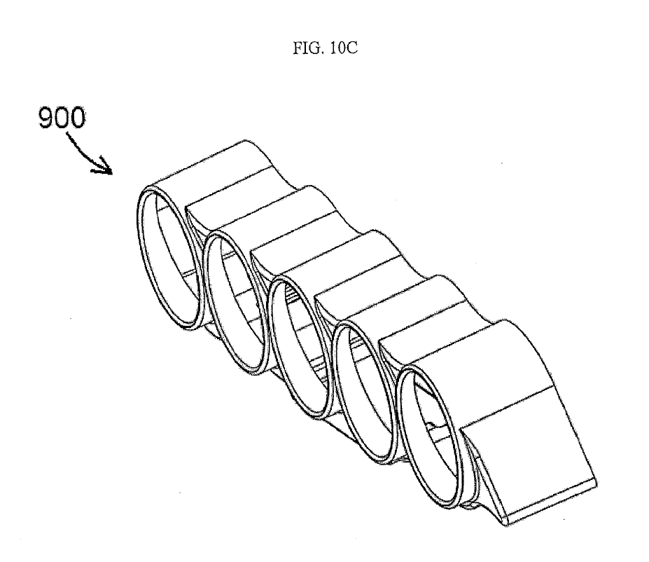

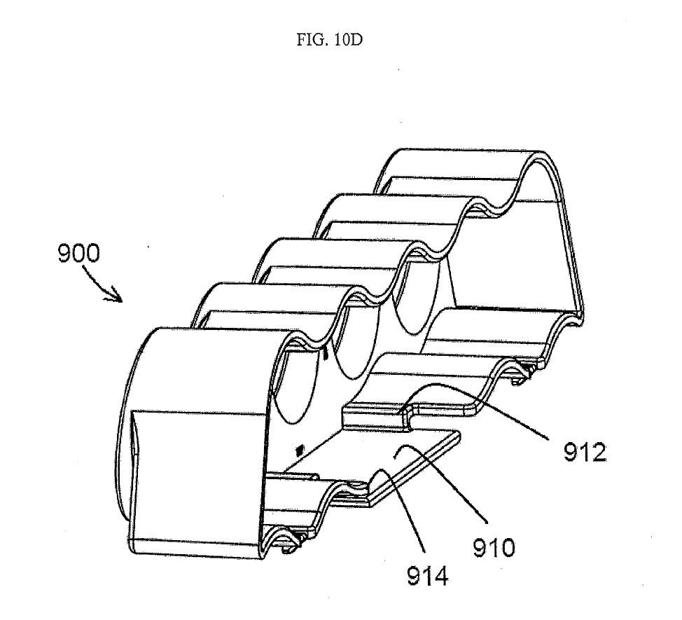

Referring to FIG. 10D it is observed the accessory 900 may include a mating section 910 which may resemble a flat plat and two side walls 912 and 914. In example embodiments, the two side walls 912 and 914 may be separated by a distance which may be about the same a width of a connecting plate 812 of the cover 800. As such, the connecting plate 812 may reside between the two side walls 912 and 914 when the accessory 900 is connected to the cover 800.

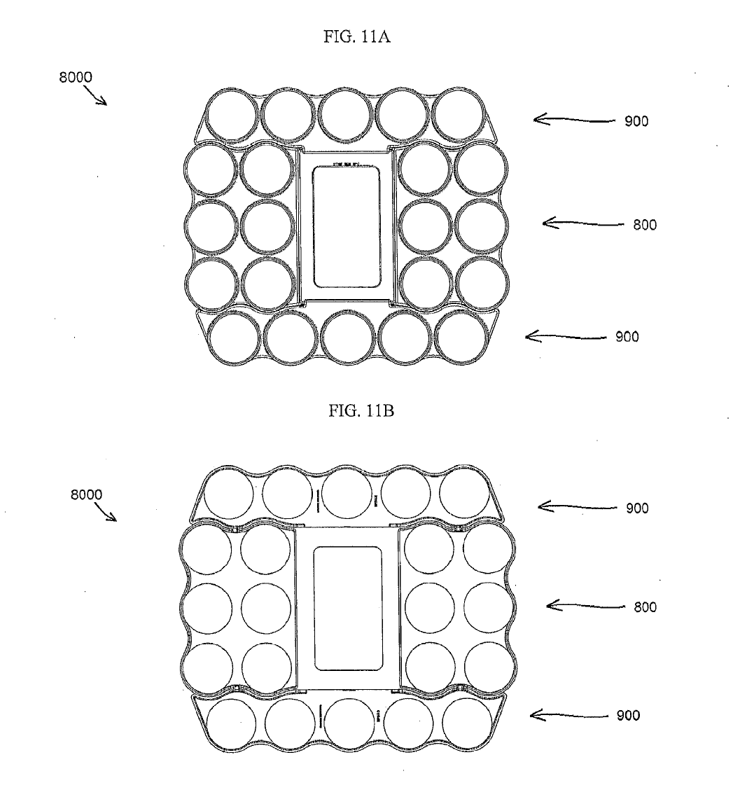

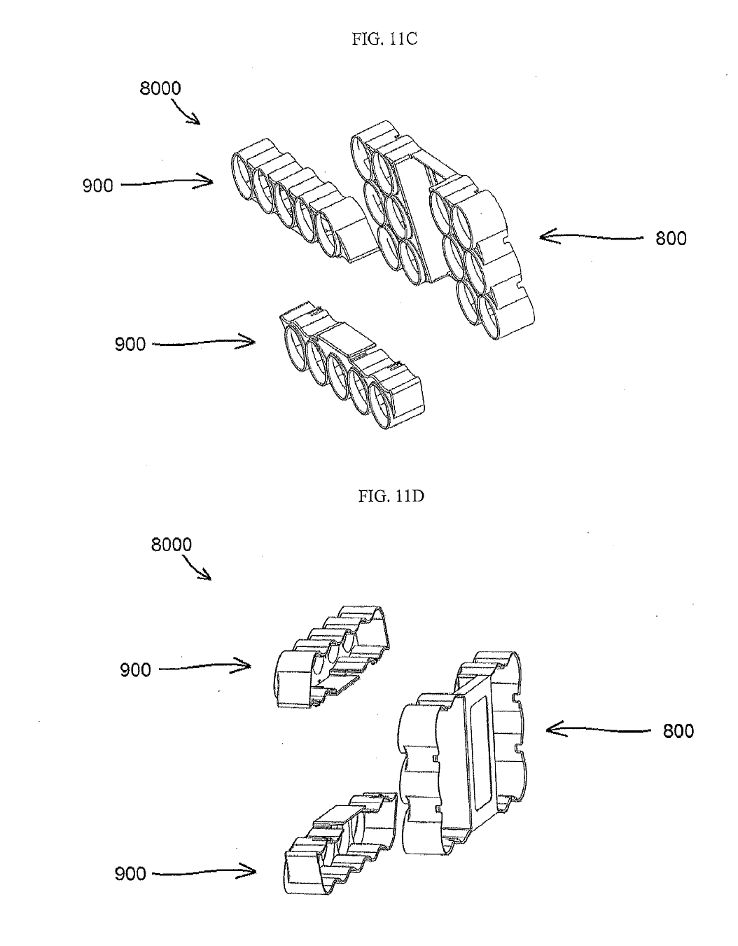

FIGS. 11A-11C illustrate a system 8000 which includes the cover 800 and two accessories 900. FIG. 11A, for example, illustrates a front view of the system 8000, FIG. 11B illustrates a second view of the system 8000, FIG. 11C illustrates a first exploded-perspective view of the system 8000, and FIG. 11D illustrates a second exploded-perspective view of the system 8000. Referring to FIGS. 11C and 11D the accessory 900 may be attached to a top of the cover 800 by manipulating the accessory 900 so that its complementary surface 920 is substantially in line with surface 850 of the cover 800. The accessory 900 may then be moved towards to the cover 800 until the cover's connecting plate 812 is inserted between the first and second side walls 912 and 914. In this configuration a bottom surface of the connecting plate 812 may face a top surface of the mating section 910. In FIGS. 9A-9D the bottom accessory 900 may be connected to the cover 800 in a similar manner.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What is claimed is:

1. A cover comprising:
an attachment section; and
at least one wing having at least one holder therein, wherein the attachment section is configured to attach to a wall socket.

2. The cover of claim 1, wherein that attachment section includes a lip.

3. The cover of claim 2, wherein the lip has a substantially rectangular perimeter having a length of about 4.5 inches and a width of about 2.75.

4. The cover of claim 3, wherein the lip encircles an aperture configured to expose an electrical socket.

5. The cover of claim 1, wherein the attachment section includes a first aperture configured to expose a first electrical socket and a second aperture configured to expose a second electrical socket.

6. The cover of claim 5, wherein each of the first and second apertures have lengths of about 1 inch to about 1.3 inches and heights of about 1 inch.

7. The cover of claim 6, wherein centers of the first and second apertures are separated by a distance of about 1.5 inches.

8. The cover of claim 7, wherein the attachment section includes a third aperture between the first and second apertures.

9. The cover of claim 1, wherein the at least one wing includes a first wing arranged at a first side of the attachment section and a second wing arranged at a second side of the attachment section.

10. The cover of claim 9, wherein the at least one holder includes a first plurality of holders arranged in the first wing and a second plurality of holders arranged in the second wing.

11. A holder body comprising:
a plurality of holders; and
a plurality of receiving ports.

12. The holder body of claim 11, wherein the plurality of receiving ports are arranged in a rectangular pattern.

13. The holder body of claim 11, wherein the receiving ports are configured to receive cylindrical members.

14. The holder body of claim 11, further comprising:
a plurality of stiffeners.

15. The holder body of claim 14, wherein the plurality of stiffeners include a plurality of horizontal stiffeners and a plurality of vertical stiffeners.

16. The holder body of claim 15, wherein at least one of the receiving ports is between two horizontal stiffeners and two vertical stiffeners.

17. A system comprising:
the holder body of claim 11; and
a connecting member, the connecting member including a plurality of interfacing members configured to interface with the plurality of receiving ports.

18. The system of claim 17, wherein the plurality of interfacing members has a cylindrical cross section.

19. An accessory comprising:
a plurality of holders; and
a mating section comprised of a substantially flat plate and two side walls.

20. The accessory of claim 19, further comprising:
a complementary surface configured to complement a surface of the cover of claim 1, wherein the two side walls are separated by a distance which is larger than a width of a connecting plate of the cover of claim 1.
